(19) United States
(12) Patent Application Publication
(10) Pub. No.: US 2022/0320480 A1
(43) Pub. Date: Oct. 6, 2022

(54) METHOD OF MANUFACTURING ALL-SOLID-STATE BATTERY

(71) Applicant: TOYOTA JIDOSHA KABUSHIKI KAISHA, Toyota-shi (JP)

(72) Inventors: Ximeng LI, Susono-shi (JP); Masumi SATO, Susono-shi (JP); Sakina KANEKO, Susono-shi (JP); Tomoya MATSUNAGA, Susono-shi (JP); Satoshi WAKASUGI, Susono-shi (JP); Hideaki NISHIMURA, Suntou-gun (JP); Mitsutoshi OTAKI, Susono-shi (JP); So YUBUCHI, Susono-shi (JP); Shohei KAWASHIMA, Susono-shi (JP); Jun YOSHIDA, Mishima-shi (JP)

(21) Appl. No.: 17/655,753

(22) Filed: Mar. 21, 2022

(30) Foreign Application Priority Data
Apr. 1, 2021 (JP) 2021-062677

(51) Int. Cl. H01M 4/04; H01M 4/38; H01M 10/44; H01M 10/052; H01M 10/0585

(52) U.S. Cl. CPC H01M 4/0447; H01M 4/38; H01M 10/446; H01M 10/052; H01M 10/0585; H01M 2004/027

(57) ABSTRACT

To improve the capacity of an all-solid-state battery, a method of manufacturing an all-solid-state battery having a cathode that contains sulfur include: performing initial charge and discharge separately at least in three cycles until a capacity of the battery reaches a design capacity, wherein a charge discharge capacity in a first cycle is at most 30% of the design capacity, and charge and discharge in a second cycle and after are performed, so that a charge discharge capacity in an n-th cycle is increased at least 1.15 times as much as a charge discharge capacity in an (n-1)-th cycle.

### FIELD

The present disclosure relates to a method of manufacturing an all-solid-state battery.

### BACKGROUND

An all-solid-state battery is provided with a cathode including a cathode active material layer, an anode including an anode active material layer, and a solid electrolyte layer disposed between them and containing a solid electrolyte.

Patent Literature 1 discloses a charging method for a lithium sulfur solid-state battery, the method comprising: a constant-current charging step; and a constant-voltage charging step executed after execution of the constant-current charging step, whereby the power storage capacity can be increased while deterioration caused by overvoltage is suppressed.

Patent Literature 2 discloses that a β single phase alloy of metallic Li and metallic Mg is contained as a negative electrode active material, and the proportion of atoms of a lithium element in the alloy is 81.80 to 99.97 atomc% when the all-solid battery is fully charged.

Patent Literature 3 discloses a method of manufacturing an all-solid lithium sulfur battery, and describes that a positive electrode mixture is prepared by using S, LiS, a conductive aid and a solid electrolyte.

### CITATION LIST

### Patent Literature

Patent Literature 1: JP 2019-140029 A

Patent Literature 2: JP 2020-184513 A

Patent Literature 3: JP 2018-026199 A

### SUMMARY

### Technical Problem

An object of the present disclosure is to provide a method of manufacturing an all-solid- state battery according to which capacity can be increased.

### Solution to Problem

As one aspect to solve the above problem, the following method is disclosed: a method of manufacturing an all-solid-state battery having a cathode that contains sulfur, the method comprising: performing initial charge and discharge separately at least in three cycles until a capacity of the battery reaches a design capacity, wherein a charge discharge capacity in a first cycle is at most 30% of the design capacity, and charge and discharge in a second cycle and after are performed, so that a charge discharge capacity in an n-th cycle is increased at least 1.15 times as much as a charge discharge capacity in an (n-1)-th cycle.

### Advantageous Effects

According to the method of manufacturing an all-solid-state battery of the present disclosure, the capacity of the battery can be increased.

### BRIEF DESCRIPTION OF DRAWINGS

FIG. 1 explanatorily shows a layer structure of an all-solid-state battery 10; and

FIG. 2 shows a flow of a method of manufacturing an all solid-state battery.

### DESCRIPTION OF EMBODIMENTS

1. All-Solid-State Battery

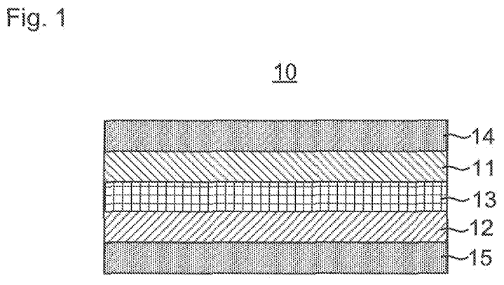

FIG. 1 is a schematic cross-sectional view showing one example of an all-solid-state battery manufactured according to a manufacturing method of the present disclosure. An all-solid-state battery 10 shown in FIG. 1 has a cathode layer 11, an anode layer 12, and a solid electrolyte layer 13 disposed between the cathode layer 11 and the anode layer 12. The all-solid-state battery 10 further has a cathode current collector 14 configured to collect a current of the cathode layer 11, and an anode current collector 15 configured to collect a current of the anode layer 12. Hereinafter each of the layers will be described.

1.1 Cathode Layer

The cathode layer 11 contains a cathode active material having an S element, a sulfur-containing compound having a P element and an S element, and a conductive aid.

For example, the thickness of the cathode layer 11 is 0.1 μm to 1000 μm. For example, the coating amount of the cathode layer 11 is larger than 3 mg/cm2, and may be at least 4 mg/cm2 and may be at least 5 mg/cm2. For example, the cathode layer may be obtained by pressing of a cathode mixture. That is, the cathode mixture contains a cathode active material having an S element, a sulfur-containing compound having a P element and an S element, and a conductive aid. Hereinafter each of the constituents will be described.

It is possible that the cathode mixture does not substantially contain an Li element. Whereby a decrease in the capacity can be suppressed. Here, a cathode mixture containing an ionic conductor (solid electrolyte) having an Li element is known. For example, when an ionic conductor formed by using Li2S as a raw material is used, capacity of a battery where such a cathode mixture is used for a cathode layer tends to low since Li2S has low water resistance. In contrast, when an Li element (that is, Li2S) is not substantially contained, a decrease in the capacity can be suppressed. Here, “not substantially contain an Li element” means that the proportion of the Li element to all the elements contained in the cathode mixture is at most 20 mol%. The proportion of the Li element may be at most 16 mol%, may be at most 8 mol%, may be at most 4 mol%, and may be 0 mol%.

[Cathode Active Material]

The cathode active material has an S element. The cathode active material is preferably elemental sulfur among S elements. An example of the elemental sulfur is octasulfur. Octasulfur has three crystal shapes that are a-sulfur (orthorhombic sulfur), (3-sulfur (monoclinic sulfur) and y-sulfur (monoclinic sulfur), any of which may be employed here.

When containing the elemental sulfur as the cathode active material, peaks of the elemental sulfur may appear in XRD measurement of the cathode mixture, or no peak thereof may appear therein. Typical peaks of elemental sulfur are at 23.05°±0.50°, 25.84°±0.50°, and 27.70°±0.50°in 2θ in XRD measurement using CuKα radiation. At the position of each of these peaks, “±0.50°” may be ±0.30°, and may be ±0.10.

Part or all of the elemental sulfur may form a solid solution along with the sulfur-containing compound described later. In other words, the cathode mixture may contain a solid solution of the elemental sulfur and the sulfur-containing compound. The S element in the elemental sulfur, and the S element in the sulfur-containing compound may have a chemical bond (S-S bond).

1.2. [Sulfur-Containing Compound]

The cathode mixture contains at least a sulfur-containing compound having a P element and an S element as a sulfur-containing compound. It is sufficient that the cathode mixture contains only a sulfur-containing compound having a P element and an S element. The cathode mixture may further contain a sulfur-containing compound having any other element (such as Ge, Sn, Si, B and Al) and an S element. In the latter case, the cathode mixture preferably contains a sulfur-containing compound having a P element and an S element as a main body of a sulfur-containing compound.

The sulfur-containing compound preferably includes an ortho structural skeleton of the P element. The ortho structural skeleton of the P element is specifically a PS4 structural skeleton. The sulfur-containing compound may include an ortho structural skeleton of an M element (Examples of M include Ge, Sn, Si, B and Al). Examples of the ortho structural skeleton of an M element include a GeS4 structural skeleton, an SnS4 structural skeleton, an SiS4 structural skeleton, a BS3 structural skeleton, and an AlS3 structural skeleton. The sulfur-containing compound may contain a sulfide of the P element (such as P2S5). The sulfur-containing compound may have a sulfide of the M element (MxSy). Here, x and y are integers leading to electroneutrality with respect to S according to M. Examples of the sulfide (MxSy) include GeS2, SnS2, SiS2, B2S3, and Al2S3. The sulfide is, for example, a residue of a starting material.

Peaks of sulfides may appear in XRD measurement of the cathode mixture, or no peak thereof may appear therein. Typical peaks of P2S5 are at 25.84°±0.50°, 30.35°±0.50°, and 31.32°±0.50° in 2θ in XRD measurement using CuKα radiation. Typical peaks of GeS2 are at 15.43°±0.50°, 26.50°±0.50°, and 28.60° ±0.50° in 2θ in XRD measurement using CuKα radiation. Typical peaks of SnS2 are at 15.02°±0.50°, 32.11°±0.50°, and 46.14°±0.50° in 2θ in XRD measurement using CuKα radiation. Typical peaks of SiS2 are at 18.36°±0.50°, 29.36°±0.50°, and 47.31°±0.50° in 2θ in XRD measurement using CuKα radiation. At the position of each of these peaks, “±0.50°” may be ±0.30°, and may be ±0.10.

As described above, the S element in the sulfur-containing compound, and the S element in the elemental sulfur (cathode active material) may have a chemical bond (S-S bond). In particular, preferably, an S element in the ortho structural skeleton and the S element in the elemental sulfur (cathode active material) have a chemical bond (S-S bond).

[Conductive Aid]

The conductive aid has a function of improving the electron conductivity of the cathode mixture. It is presumed that the conductive aid functions as a reducing agent to reduce the elemental sulfur when, for example, the raw material mixture is subjected to mechanical milling. The conductive aid is preferably present as dispersing in the cathode mixture.

Examples of the conductive aid include carbon materials and metallic materials. Examples of the carbon materials include vapor grown carbon fiber (VGCF), acetylene black, activated carbon, furnace black, carbon nanotubes, Ketjen black, and graphene. The content of the conductive aid in the cathode mixture is the same as a content of a conductive aid in the raw material mixture described later, and thus, description thereof is omitted here.

[Structure of Cathode Mixture]

There are no particular limitations on the molar ratio (P/S) of the P element to the S element in the cathode mixture. For example, this molar ratio is at least 0.03, and may be at least 0.06, may be at least 0.09, and may be at least 0.12. The molar ratio (P/S) is, for example, at most 0.5, and may be at most 0.3, and may be at most 0.27. The denominator of the molar ratio (P/S) means the amount of all the atoms of the S element included in the cathode mixture. Since both the cathode active material and the sulfur-containing compound in the present disclosure include an S element, the amount of the S element in both thereof are added up.

The cathode mixture according to the present disclosure may include an M element (M is Ge, Sn, Si, B or Al), or may include no M element.

1.2. Anode Layer

The anode layer 12 is a layer containing at least an anode active material. The anode active material preferably has an Li element. Examples of such an anode active material include simple lithium and lithium alloys. Examples of the lithium alloys include Li-In alloys. The anode active material preferably has an Na element. Examples of such an anode active material include simple sodium and sodium alloys.

The anode layer 12 may contain at least one of a solid electrolyte, a conductive aid, and a binder as necessary. The conductive aid the same as described above for the cathode mixture.

Examples of the solid electrolyte include sulfide solid electrolytes, oxide solid electrolytes, nitride solid electrolytes, and halide solid electrolytes. Among them, a sulfide solid electrolyte is preferable. The sulfide solid electrolyte preferably has an Li element, an A element (A is at least one of P, Ge, Si, Sn, B and Al), and an S element. The sulfide solid electrolyte may further have a halogen element. Examples of the halogen element include an F element, a Cl element, a Br element, and an I element. The sulfide solid electrolyte may further have an O element.

Examples of the sulfide solid electrolyte include Li2S-P2S5, Li2S-P2S5-LiI, Li2S-P2S5-GeS2, Li2S-P2S5-Li2O, Li2S-P2S5-Li2O-LiI, Li2S-P2S5-LiI-LiBr, Li2S-SiS2, Li2S-SiS2-LiI, Li2S-SiS2-LiBr, Li2S-SiS2-LiCl, Li2S-SiS2-B2S3-LiI, Li2S-SiS2-P2S5-LiI, Li2S-B2S3, Li2S-P2S5-ZmSn (m and n are positive numbers. Z is any of Ge, Zn and Ga), Li2S-GeS2, Li2S-SiS2-Li3PO4, and Li2S-SiS2-LixMOy (x and y are positive numbers. M is any of P, Si, Ge, B, Al, Ga and In).

Examples of the binder include fluorine-based binders such as polyvinylidene fluoride (PVDF).

The thickness of the anode layer 12 is, for example, 0.1 μm to 1000 μm.

1.3. Solid Electrolyte Layer

The solid electrolyte layer 13 is a layer formed between the cathode layer 11 and the anode layer 12. The solid electrolyte layer 13 is a layer containing at least a solid electrolyte, and may contain a binder if necessary. The solid electrolyte and the binder may be considered the same as those for the anode layer 12.

The proportion of the solid electrolyte contained in the solid electrolyte layer 13 is, for example, at least 50 volume%, and may be at least 70 volume%, and may be at least 90 volume%.

The thickness of the solid electrolyte layer is, for example, 0.1 μm to 1000 μm. [0031]

1.4. Structure of All-Solid-State Battery

The all-solid-state battery 10 has the above described cathode layer, anode layer and solid electrolyte layer. Usually, the all-solid-state battery 10 further has a cathode current collector 14 configured to collect a current of the cathode layer 11, and an anode current collector 15 configured to collect a current of the anode layer 12. Examples of the material of the cathode current collector 14 include SUS, aluminum, nickel, iron, titanium, and carbon. Examples of the material of the anode current collector 15 include SUS, copper, nickel, and carbon.

2. Method of Manufacturing All-Solid-State Battery

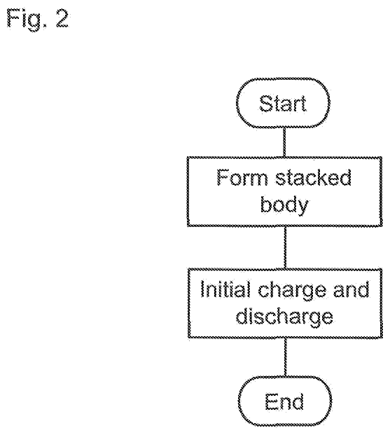

FIG. 2 is a flowchart showing one example of the flow of the method of manufacturing an all-solid-state battery in the present disclosure. As can be seen from FIG. 2, in this manufacturing method, a stacked body having the cathode layer 11, the anode layer 12, and the solid electrolyte layer 13 disposed between the cathode layer 11 and the anode layer 12 is formed (step of forming a stacked body), and next the stacked body is subjected to initial charge and discharge under predetermined conditions (initial charging and discharging step), whereby an all-solid-state battery having an improved capacity is obtained. Each of the steps will be described as follows.

2.1. Step of Forming Stacked Body

The step of forming a stacked body in the present disclosure is a step of forming the stacked body having the cathode layer, the solid electrolyte layer, and the anode layer in this order. The cathode layer is formed with the above described cathode mixture. The stacked body has at least the cathode layer, the solid electrolyte layer, and the anode layer, and may further have the cathode current collector and an anode current collector. The solid electrolyte layer, the anode layer, and other members are the same as those in the above description.

An example of a method of forming the stacked body is a pressing process. Order of the formation of the stacked body is not particularly limited. For example, one may form the solid electrolyte layer by pressing, thereafter form the cathode layer on one surface side of the solid electrolyte layer by pressing, and thereafter form the anode layer on the other surface side of the solid electrolyte layer by pressing. One may also form at least two layers of the cathode layer, the solid electrolyte layer and the anode layer at the same time by pressing. One may also use a slurry when forming the cathode layer, the solid electrolyte layer and the anode layer.

Hereinafter a way of the pressing does not matter, but examples of the pressing include roll pressing and cold isostatic pressing (CIP).

The pressure in the pressing is, for example, at least 0.1 t/cm2, and may be at least 0.5 t/cm2, and may be at least 1 t/cm2; and is, for example, at most 10 t/cm2, and may be at most 8 t/cm2, and may be at most 6 t/cm2.

2.2. Initial Charging and Discharging Step

The initial charging and discharging step in the present disclosure is a step of subjecting initial charge and discharge to the stacked body. Here, “initial” in the initial charge and discharge is different from “the first time”. The initial charge and discharge includes charge and discharge in a plurality of cycles but not in one cycle.

In an initial charging step in the method of manufacturing an all-solid-state battery according to the present disclosure, charge and discharge at least in three cycles under the following conditions are performed. That is, charge and discharge is performed at least in three cycles separately until the capacity of the stacked body reaches a design capacity, as satisfying the following conditions:

charge and discharge in the first cycle (the first time) is performed, so that the capacity of the stacked body is at most 30% of the design capacity; and charge and discharge is performed separately, so that the number of the cycles until the capacity of the stacked body reaches the design capacity is at least 3: at this time, charge and discharge is performed, so that the charge discharge capacity in the n-th cycle is at least 1.15 times as much as that in the (n-1)-th cycle.

The all-solid-state battery is manufactured according to the foregoing method of manufacturing an all-solid-state battery, whereby the capacity thereof can be improved.

In an all-solid-state battery having a cathode that contains S, the cathode expands and shrinks when the battery is charged and discharged. The solid electrolyte layer cannot bear stress at this time, and thus cracks to lead to a short circuit. Conventionally, for example, the thickness of the solid electrolyte layer is increased, whereby cracking is dealt with. In view of decrease in the resistance of the battery, the thinner the solid electrolyte layer is, the more desirable. According to the present disclosure, a decreased concentration of stress of the sulfur cathode results in suppressed local expansion and shrinkage, and thus suppressed cracking of the solid electrolyte layer, which makes it possible to improve the capacity.

The foregoing is more specifically as follows. The Li ion conductivity of a sulfur cathode is very low before Li is inserted. Therefore, when Li of a design capacity is inserted in charging and discharging in the first cycle, the reaction is concentrated to cause local expansion. Thus, a small amount of Li is repeatedly inserted and liberated as the present disclosure, whereby the Li ion conductivity of the sulfur cathode is gradually improved, and local expansion is suppressed, whereby the obtained capacity can be improved. The above described phenomenon, that is, the solid electrolyte layer cannot bear stress at this time, and thus cracks to lead to a short circuit, also progresses by the concentration of the reaction. Therefore, charge and discharge starts with a small capacity in the first cycle, and the number of the cycles of charge and discharge is increased as the capacity is gradually increased, so that the capacity of the stacked body reaches the design capacity, which makes the effect notable.

3. Examples

Hereinafter examples will be shown, to further specifically describe the present disclosure. Each operation such as weighing, synthesizing, and drying was carried out in an Ar atmosphere unless otherwise mentioned in particular.

3.1. Preparing Stacked Body

[Preparing Cathode Mixture]

Elemental sulfur S (cathode active material produced by Kojundo Chemical Laboratory Co., Ltd.), P2S5 (sulfide) and VGCF (trademark, SHOWA DENKO K.K., conductive aid) were prepared. They were weighed, so that the weight ratio, S:P2S5:VGCF was 52.3:19.2:28.3. These raw materials were mixed and kneaded in an agate mortar for 15 minutes, through which the raw material mixture was obtained. The obtained raw material mixture was put into a jar of 45 ml for planetary ball milling made from ZrO2, 96 g of ZrO2 balls of 4 mm in diameter was further put into the jar, and then the jar was completely sealed. This jar was attached to a planetary ball mill machine of P7 manufactured by Fritsch, and subjected to mechanical milling for 48 hours in total in which a cycle of: 1-hour mechanical milling at 510 rpm in disk rotation speed; a 15-minute rest; 1-hour mechanical milling reversely at 510 rpm in disk rotation speed; and a 15-minute rest was repeated. Thereby a cathode mixture was obtained.

[Preparing Cathode Layer]

A mesitylene and styrene-butadiene rubber (SBR) solution of 5 wt% styrene-butadiene rubber and 5 wt% mesitylene solution was put, and thereafter mixed with a mixer (TTM-1 manufactured by Sibata Scientific Technology Ltd.) for 3 minutes, and with an ultrasonic dispersive device (UH-50 manufactured by SMT Corporation) for 30 seconds. The above prepared cathode mixture was put to this mixture, and thereafter mixed with the ultrasonic dispersive device for 30 seconds and with the mixer for 3 minutes. This mixing was repeated twice. Aluminum foil was coated with this mixture as a cathode current collector, using an applicator having a coating gap (240 μm), and was dried on a hot plate at 100° C. for 30 minutes, to form a cathode layer.

[Preparing Solid Electrolyte Layer]

LiI-LiBr-Li2S-P2S5 (having a particle diameter D50 of 0.5 μm) as a sulfide solid electrolyte, a 5 wt% acrylonitrile butadiene styrene rubber (ABS) solution of heptane, and butyl butyrate were added into a vessel made from polypropylene, and were mixed with the ultrasonic dispersive device for 30 seconds, with the mixer for 3 minutes, and further with the ultrasonic dispersive device for 30 seconds. Aluminum foil was coated with this mixture using an applicator according to a blade method, so that the thickness of the mixture was 100 μm, and dried on a hot plate at 150° C. for 30 minutes. Then, a sulfide solid electrolyte layer stacked on the aluminum foil was obtained.

Here, “D50” means a particle diameter at a 50% integrated value in a volume-based particle diameter distribution that is measured using a laser diffraction and scattering method.

[Stacking]

The solid electrolyte layer was put on the cathode layer and pressed at 600 MPa, through which a first layer was obtained. As a second layer, Li foil (100 μm) was put on an anode current collector (copper foil), and pressed at 100 MPa. The first layer and the second layer were pressed at 100 MPa, and then a pressed body is prepared. The obtained pressed body was enclosed and at the same time laminated, through which a laminated cell was obtained. This laminated cell was restrained at 10 MPa, to form a stacked body.

3.2. Initial Charge and Discharge

The obtained stacked body was discharged and then charged at a constant current at an hour rate of 10 (C/10) in an environment at 60° C.

In Comparative Example 1, the stacked body was discharged up to 1.5 V, and after a 10-minute rest, charged up to 3.1 V. The discharging was cut at 1.5 V, and the charging was cut at 3.1 V. In Comparative Example 1, the stacked body was charged, so that the capacity thereof reached 100% of a design capacity in the first cycle (first time).

In Examples 1 to 5, each of the stacked bodies was charged, so that the capacity thereof was at the proportion to the design capacity as shown in Table 1 in the first cycle. Thereafter discharging and charging in the second cycle and after were each cut when the capacity was times according to Table 1. Each of the stacked bodies were charged and discharged as the cut capacity was increased until the capacity thereof reached the design capacity. Then, the number of cycles until the capacity reached the design capacity was obtained. Here, one cycle meant discharging once and charging once.

3.3. Results

The maximum charge capacity (mAh) obtained until a short circuit occurred was obtained. The results are shown in Table 1. In Table 1, the value in the “first cycle” column is the proportion of the charge discharge capacity in the first cycle to the design capacity, which is represented by percentage. In Table 1, the value in the “times in the second cycle and after” column is times of the capacity in the n-th cycle to the capacity in the (n-1)-th cycle in charge and discharge in the second cycle and after. In Table 1, the value in “the number of cycles” column is the number of cycles of charge and discharge until the capacity of the stacked body reached the design capacity.

In Table 1, the value in “capacity” column is the maximum charge capacity (mAh) obtained until a short circuit occurred.

TABLE 1

| | First | Times in second | Number | |
|---|---|---|---|---|
| | cycle | cycle and after | of | Capacity |
| | (%) | (times) | cycles | (mAh) |
| Comparative | 100 | — | 1 | 0.2 |
| Example 1 | | | | |
| Example 1 | 30 | 1.85 | 3 | 2.0 |
| Example 2 | 30 | 1.15 | 10 | 2.0 |
| Example 3 | 10 | 1.40 | 8 | 2.5 |
| Example 4 | 2 | 2.00 | 7 | 2.5 |
| Example 5 | 10 | 1.80 | 5 | 2.5 |

As can be seen from Table 1, the all-solid-state batteries according to Examples made it possible to largely improve the capacities thereof, compared to Comparative Example 1.

Reference Signs List

10 all-solid-state battery

11 cathode layer

12 anode layer

13 solid electrolyte layer

14 cathode current collector

15 anode current collector

What is claimed is:

1. A method of manufacturing an all-solid-state battery having a cathode that contains sulfur, the method comprising:
performing initial charge and discharge separately at least in three cycles until a capacity of the battery reaches a design capacity, wherein
a charge discharge capacity in a first cycle is at most 30% of the design capacity, and
charge and discharge in a second cycle and after are performed, so that a charge discharge capacity in an n-th cycle is increased at least 1.15 times as much as a charge discharge capacity in an (n-1)-th cycle.
